(19) United States
(12) Patent Application Publication
(10) Pub. No.: US 2013/0074460 A1
(43) Pub. Date: Mar. 28, 2013

(54) DUST COLLECTOR

(71) Applicants: Satoshi Sakuragi, Tsushima-shi (JP); Yoshifumi Kamakura, Tsushima-shi (JP)

(72) Inventors: Satoshi Sakuragi, Tsushima-shi (JP); Yoshifumi Kamakura, Tsushima-shi (JP)

(21) Appl. No.: 13/572,544

(22) Filed: Aug. 10, 2012

(30) Foreign Application Priority Data
Sep. 26, 2011 (JP) P2011-209532
Sep. 26, 2011 (JP) P2011-209533

(51) Int. Cl. B01D 46/42

(52) U.S. Cl. 55/471

(57) ABSTRACT

A dust collector includes a housing provided with a suction port and a discharge port, a motor-driven fan located in a fan chamber in the housing, an air suction chamber located between the suction port and the fan chamber, a main filter located in the air suction chamber, a drum member that is so located in the fan chamber as to enclose the fan, and a drum filter mounted around an outer circumferential plane of the drum member. The main filter is comprised of a box-shaped filter case that is ejectable from the air suction chamber and two or more filter elements that are set in the filter case in layers, and the filter elements are selected from a plurality of filters which have the same or different performances.

### CROSS REFERENCE TO RELATED APPLICATIONS

The Present application claims priority from Japanese Patent Application No. 2011-209532 of Sakuragi et. al., filed on Sep. 26, 2011, and Japanese Patent Application No. 2011-209533 of Sakuragi et. al., filed on Sep. 26, 2011, the disclosures of which are hereby incorporated into the present application by reference.

### BACKGROUND OF THE INVENTION

1. Field of the Invention

The present invention relates to a dust collector for use in such facilities as a machine shop equipped with various machine tools, for filtering and trapping oil-mist laden gas which contains oil mist and dust.

2. Description of Related Art

As is known in JP2002-166117A, by way of example, a conventional dust collector for use in a machine shop includes a main filter (louver unit), a drum filter and an after filter (final filter). The dust collector, when it runs a fan and draws in from a suction port oil-mist laden gas, which contains oil mist (including oil smoke) and dust, filtrates the gas with the filters and exhausts the filtrated gas from a discharge port.

This dust collector traps, with the after filter, fine particles and dust contained in the gas having passed through the main filter and drum filter.

However, with the conventional dust collector, collection efficiency and maintenance frequency cannot be changed according to actual operational status of the shop.

Accordingly, a new dust collector with a different performance has to be introduced when, by way of example, a change of a cutting fluid for a cutting machine reduces oil mist and dust, or when improved collection efficiency is required in order to respond to maintenance related circumstances.

Further, a dust collector mounted on a machine tool is sometimes desired to be remounted on another machine tool. However, it will not work out if the collection efficiency of the dust collector does not suit the collection efficiency required for the machine tool on which the dust collector is to be remounted.

In the conventional dust collector, moreover, an ejection opening for taking out the main filter (louver unit) and an ejection opening for taking out the drum filter are respectively covered by different cover members, and a box for housing the main filter and the suction port are formed on the cover member for covering the ejection opening for the drum filter.

In order to do such maintenance as inspection and cleaning on the drum filter, therefore, the cover member covering the drum filter ejection opening must be removed, together with a duct connected to the suction port. This has made the maintenance on the filter considerably complicated and troublesome.

### SUMMARY OF THE INVENTION

An object of the present invention is to provide a dust collector whose collection efficiency is easy to change according to use.

Another object of the present invention is to provide a dust collector which is easy to do such maintenance as inspection, cleaning and replacement on filters.

The object of the invention will be achieved by a following dust collector: The dust collector includes a housing provided with a suction port and a discharge port, a motor-driven fan located in a fan chamber in the housing, an air suction chamber located between the suction port and the fan chamber, a main filter located in the air suction chamber, a drum member that is so located in the fan chamber as to enclose the fan, and a drum filter mounted around an outer circumferential plane of the drum member. When an oil mist laden gas is sucked into the housing via the suction port due to running of the fan, the dust collector filtrates the gas with the main filter, and then with the drum filter, and exhausts the filtrated gas from the discharge port. The main filter is comprised of a box-shaped filter case that is ejectable from the air suction chamber and two or more filter elements that are set in the filter case in layers, and the filter elements are selected from a plurality of filters which have the same or different performances.

With this configuration, collection efficiency and maintenance frequency of the dust collector will be easily changed by taking the filter case out of the air suction chamber and changing the selection of the filter elements to be set in the main filter. Accordingly, the dust collector of the invention is capable of responding to such instances where, after being introduced in a shop, collection efficiency must be changed due to change of a cutting fluid etc. or where the dust collector is remounted on other machine tool which demands different collection efficiency, merely by changing the selection of the filter elements to be set in the main filter, without having to repurchasing a new dust collector.

In the dust collector of the invention, the drum filter may be formed into a generally band shape and be so configured as to be moved along a length direction of the drum filter so as to be taken in and out of the fan chamber and wrapped around the outer circumferential plane of the drum member. In this case, the drum filter may be comprised of one filter selected from a plurality of filters with different performances.

With this configuration, performance of the dust collector can be easily changed by taking the drum filter out of the fan chamber along its length direction and wrapping the drum member with another drum filter with different performance. Moreover, since not only the selection of the filter elements for the main filter but also the selection of the filter element for the drum filter can be changed, combinations of filter elements will enable diverse performance possibilities of the dust collector.

The above dust collector may also be provided with an air exhaust chamber located between the fan chamber and the discharge port, an after filter case removably located in the air exhaust chamber, and an after filter that is set in the after filter case and filtrates a gas having passed through the drum filter. In this instance, the after filter may be comprised of one filter selected from a plurality of filters with different performances.

With this configuration, performance of the dust collector can be easily changed by taking the after filter case out of the air exhaust chamber and replacing the after filter with another filter element of different performance. Since the selection of the filter element is also possible with the after filter in addition to the main filter and the drum filter, there will be further diverse performance possibilities of the dust collector depending on combination of filter elements.

Further, the dust collector of the invention includes a housing provided with a suction port and a discharge port, a motor-driven fan located in a fan chamber in the housing, an air suction chamber located between the suction port and the fan chamber, a main filter located in the air suction chamber, the main filter being comprised of a box-shaped filter case that is ejectable from the air suction chamber and a filter element set in the filter case, a drum member that is so located in the fan chamber as to enclose the fan, a drum filter mounted around an outer circumferential plane of the drum member. When an oil mist laden gas is sucked into the housing via the suction port due to running of the fan, the dust collector filtrates the gas with the main filter, and then with the drum filter, and exhausts the filtrated gas from the discharge port. The dust collector further includes a first main filter ejection opening for ejection of the main filter out of the air suction chamber and a first drum filter ejection opening for ejection of the drum filter out of the fan chamber, the first main filter ejection opening and the first drum filter ejection opening being disposed side by side on a lateral side of the housing, and a first cover member that covers both the first main filter ejection opening and the first drum filter ejection opening.

With this configuration, the air suction chamber housing the main filter and the fan chamber housing the drum filter can be both checked from a side of the housing only by removing the first cover member. If the filter case is further taken out of the air suction chamber, the filter elements of the main filter can be checked, thus facilitating maintenance work on the filters, such as inspection and replacement.

In the above dust collector, the drum filter is formed into a generally band shape and is so configured as to be moved along a length direction of the drum filter so as to be taken in and out of the first drum filter ejection opening and wrapped around the outer circumferential plane of the drum member. In the meantime, the dust collector desirably includes a first guide element that guides a leading end region of the drum filter inserted from the first drum filter ejection opening to move along a circumferential direction of the drum member and toward the first drum filter ejection opening.

This configuration will facilitate mounting of the drum filter, since the first guide element helps move the leading end region of the drum filter along a circumferential direction of the drum member and toward the first drum filter ejection opening only by inserting the drum filter from the first drum filter ejection opening and moving it along its length direction.

It will also be appreciated that the dust collector further includes a second main filter ejection opening for ejection of the main filter out of the air suction chamber and a second drum filter ejection opening for ejection of the drum filter out of the fan chamber, the second main filter ejection opening and the second drum filter ejection opening being disposed side by side on a lateral side of the housing opposite from the first main filter ejection opening and the first drum filter ejection opening, such that the main filter can be taken in and out of the air suction chamber either via the first main filter ejection opening or via the second main filter ejection opening whereas the drum filter can be taken in and out of the fan chamber either via the first drum filter ejection opening or via the second drum filter ejection opening, and that the dust collector further includes a second cover member that covers both the second main filter ejection opening and the second drum filter ejection opening. Further, the first guide element is located on an inner surface of the second cover member.

With this configuration, if the dust collector is located on such a location that the first cover member cannot be removed, such maintenance as inspection and replacement of the filter can be easily done by removing the second cover member.

It will also be appreciated that the dust collector further includes a second guide element that is located on an inner surface of the first cover member and guides a leading end region of the drum filter to move along a circumferential direction of the drum member and toward the second drum filter ejection opening when the drum filter is inserted from the second drum filter ejection opening and moved along a length direction thereof to be mounted around the drum member.

With this configuration, when the drum filter is replaced by removing the second cover member, the second guide element located on the inner surface of the first cover member will help wind a new drum filter around the drum member, thus facilitating the mounting of the drum filter via the second drum filter ejection opening.

### BRIEF DESCRIPTION OF DRAWINGS

FIG. 1 is a perspective view of a dust collector embodying the invention as viewed from the front side;

FIG. 2 is an exploded perspective view of the dust collector of FIG. 1;

FIGS. 3a, 3b and 3c are front views of demisters employable in the dust collector of FIG. 1;

FIG. 4a is a perspective view of an air filter employable in the dust collector of FIG. 1;

FIG. 4b is a perspective view of an oil blotter employable in the dust collector of FIG. 1;

FIG. 5 is a vertical sectional view of the dust collector of FIG. 1 taken along a suction direction;

FIG. 6a is a perspective view of the dust collector of FIG. 1 from which a right side cover is removed;

FIG. 6b is a perspective view of the dust collector from which a cartridge box (main filter) is further taken out;

FIG. 7 is a perspective view showing filter elements of the main filter, i.e., a demister, an air filter, an oil blotter, and a louver are taken out of the cartridge box;

FIG. 8a illustrates removal of a drum filter, which begins with removal of a filter holding member;

FIG. 8b illustrates the way the drum filter is drawn out;

FIG. 9a illustrates the way a drum filter is wrapped around a drum member in order to mount the drum filter on the drum member;

FIG. 9b illustrates the way the mounting of the drum filter is completed;

FIG. 10 is a perspective view showing the left side of the dust collector of FIG. 1;

FIG. 11 is a perspective view showing an after filter taken out of the dust collector;

FIG. 12a is a perspective view of a metal drum filter employable in the dust collector;

FIG. 12b is a perspective view of a high performance after filter employable in the dust collector; and

FIG. 13 is a table showing various models with different combinations of filters to be mounted on the dust collector and their characteristics.

### DESCRIPTION OF PREFERRED EMBODIMENTS

Preferred embodiments of the present invention are described below with reference to the accompanying drawings. However, the invention is not limited to the embodiments disclosed herein. All modifications within the appended claims and equivalents relative thereto are intended to be encompassed in the scope of the claims.

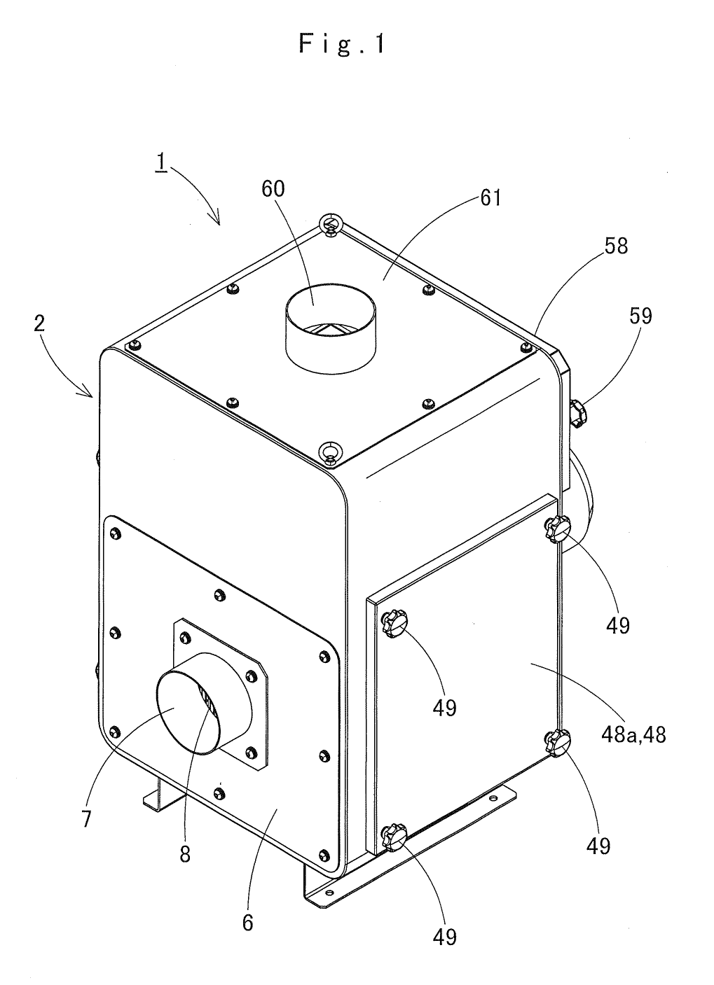

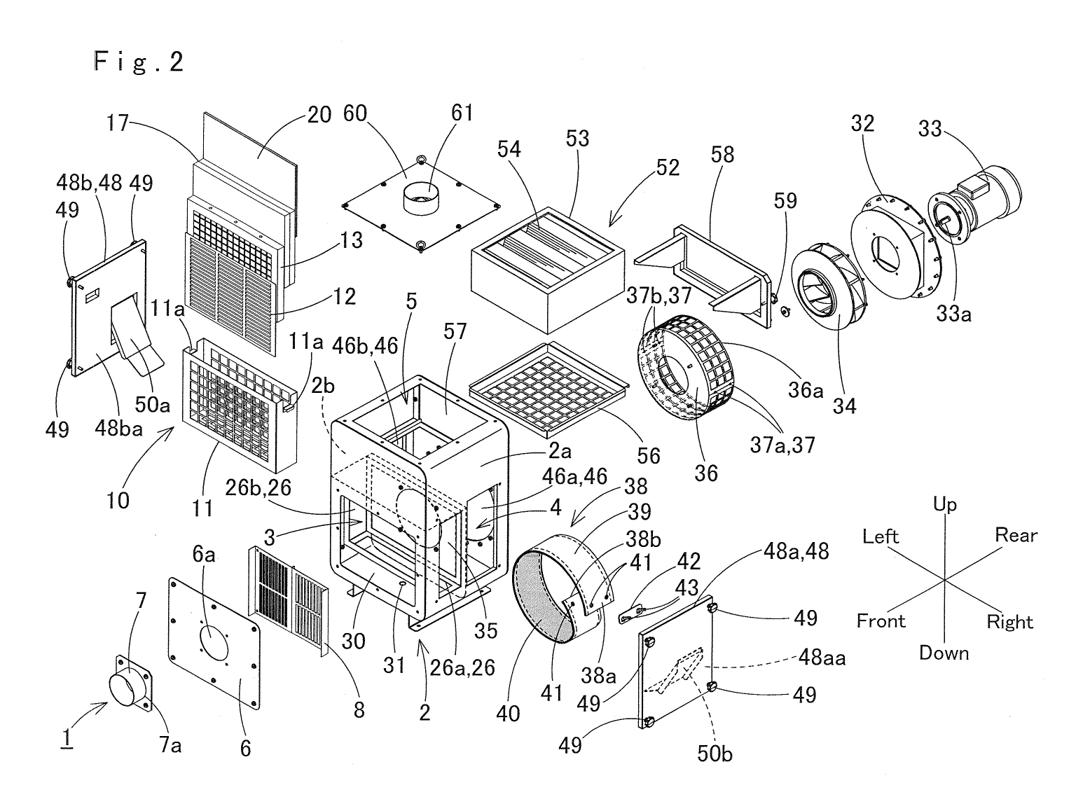

FIG. 1 is a perspective view of a dust collector 1 embodying the present invention. FIG. 2 is an exploded perspective view of the dust collector 1. The dust collector 1 takes in and filtrates a gas containing oil mist and dust, hereinafter referred to as the “oil-mist laden gas,” which is generated along with use of such machine tools as a machining center and a NC lathe.

In the following description, “oil mist” is intended to include mist that results from spattering of cutting fluids for machine tools, after hitting workpieces and/or tools as well as oil smoke that is generated when cutting fluids vapor or is decomposed due to heat at cutting points. “Dust” refers to cutting swarf, turning or the like created by cutting and grinding. Front/rear, left/right and up/down directions are intended to refer to the directions shown in FIG. 2.

As shown in FIGS. 1 and 2, the dust collector 1 is comprised of a generally rectangular parallelepiped housing (casing) 2 and various parts assembled with the housing 2. The housing 2 includes a main filter chamber (or an air suction chamber) 3, which houses a main filter 10, a drum filter chamber (or a fan chamber) 4, which houses a drum filter 38, an after filter chamber (or an air exhaust chamber) 5, which houses an after filter 52. The main filter chamber 3 and the drum filter chamber 4, and the drum filter chamber 4 and after filter chamber 5 communicate respectively each other such that an oil-mist laden gas taken in the dust collector 1 moves there through.

The housing 2 has on the front side a front cover 6. The front cover 6 is provided with a generally circular opening 6a, to which a generally tubular suction port 7 is attached, by a flange 7a. On the back side of the front cover 6 is a first louver (or baffle plate) 8 which is provided with vertical slits. When a later-described centrifugal fan 34 runs to suck in an oil-mist laden gas via the suction port 7, the gas hits the first louver 8 firstly and is diffused toward left and right directions while being freed of coarse dust. The first louver 8 also helps fine particles in the oil-mist laden gas to clump together.

The main filter chamber 3 is located at the rear of the first louver 8 in the housing 2. A main filter cartridge 10 is housed in the main filter chamber 3. The main filter 10 has such a composition that a second louver 12, a demister 13, an air filter (or a primary synthetic resin filter) 17 and an oil blotter (or a secondary synthetic resin filter) 20 are disposed one behind another in that order from the front side, and housed in a cartridge box (or a filter case) 11, which is formed generally into a basket. The front wall and rear wall of the cartridge box 11 are respectively formed into a lattice such that a gas sucked into the dust collector 1, hereinafter referred to as the “sucked-in gas,” passes them through. On top of the left side wall and right side wall of the cartridge box 11 are, respectively, a grip tab 11a for an operator to hold when taking the main filter 10 out of the housing 2 or main filter chamber 3.

The second louver 12 is provided with horizontal slits so as to diffuse the sucked-in gas having passed through the first louver 8 in an up and down direction and to remove cutting swarf and powder dust from the sucked-in gas.

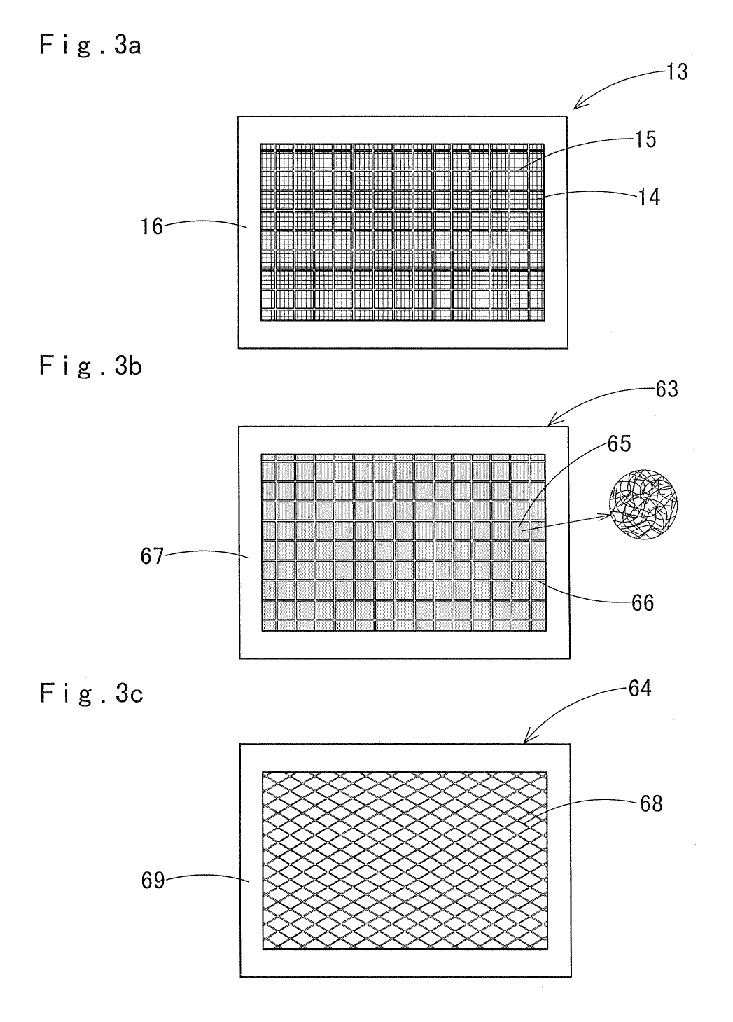

FIG. 3a depicts the demister 13, which has such a structure that a plurality of layers of metal filters 14 are sandwiched by wire meshes 15 at the front and rear, and further clamped by a front frame 16 and a rear frame (not illustrated). Each of the metal filters 14 is formed by weaving or netting numerous aluminum wires extending in an up and down direction and in a left and right direction. The demister 13 is provided to collect cutting swarf, powder dust and oil mist contained in the sucked-in gas which has passed through the second louver 12.

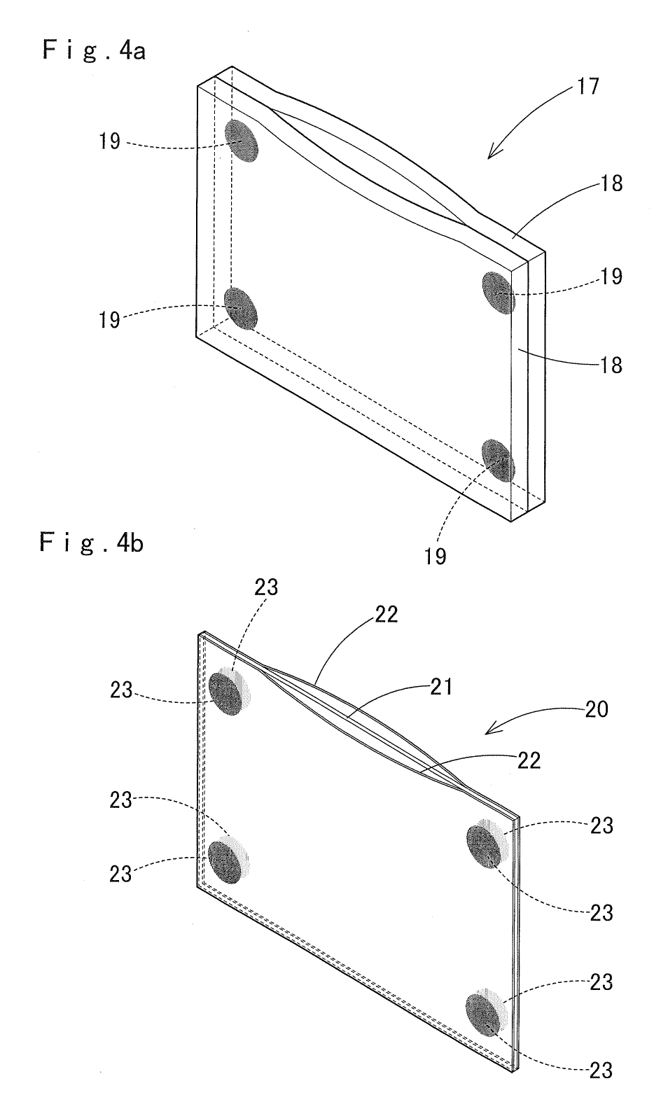

The air filter (primary synthetic resin filter) 17 is formed of a sponge-like material such as polyurethane foam. More specifically, as shown in FIG. 4a, the air filter 17 is comprised of two sheets of sponge-like filter elements 18, of generally the same size as the demister 13 as viewed from the front, laid one above the other and spot heat sealed at four corners thereof, thus unitized (see the sealed portions 19 in FIG. 4a).

The air filter 17 is provided to collect oil mist contained in the sucked-in gas having passed through the demister 13, i.e., oil mist of smaller particle size than the oil mist collected by the demister 13. The two filter elements 18 are unitized by heat sealing because this way the filtration performance is better maintained than an instance where the filter elements 18 are unitized by sewing.

If the filter elements 18 are sewn together at their peripheries so as to be unitized, vicinities of the sewn regions will be clamped against each other, which will degrade the filtration performance of the filter elements 18. To avoid such an undesirable effect, the filter elements 18 are unitized by heat sealing.

The oil blotter (or a secondary synthetic resin filter) 20 is comprised of a sponge-like filter element of similar material to the air filter 17 and a fibrous filter element formed, by way of example, of polyester nonwoven fabric.

More specifically, as shown in FIG. 4b, the oil blotter 20 is comprised of a sheeted, sponge-like filter element 21, of generally the same size as the demister 13 as viewed from the front, and fibrous filter elements 22 which are identical to the filter 21 in shape and sandwich the filter 21. The sponge-like filter element 21 and fibrous filter elements 22 are spot heat sealed at four corners thereof, thereby unitized (see the sealed portions 23 in FIG. 4b). The oil blotter 20 is provided to sorb oil mist contained in the sucked-in gas having passed through the air filter 17. For the same reason as the air filter 17, heat sealing is adopted to unitize the three filters.

As shown in FIG. 2, the housing 2 includes, respectively on the right side 2a and left side 2b, a main filter ejection opening 26, via which the main filter 10 (cartridge box 11) constructed as described above is taken out of the housing 2 (main filter chamber 3).

To paraphrase, a right main filter ejection opening (or a first main filter ejection opening) 26a and a left main filter ejection opening (or a second main filter ejection opening) 26b are so formed on the housing 2 as to confront each other, on opposite sides of the main filter chamber 3. Thus the main filter 10 can be taken out of the housing 2 in a left and right direction, either via the right side 2a or via the left side 2a.

The housing 2 further includes on the bottom wall 30 a drain hole 31, which serves to let oil droplets out of the dust collector 1. Oil droplets are formed of oil mist, which is contained in the sucked-in gas, clumping together in the main filter 10. Oil droplets collected by the demister 13, by way of example, run down the aluminum wires. An unillustrated drain pipe is connected to the drain hole 31.

The housing 2 is provided on the backside with a motor base 32, which covers up the backside of the housing 2. An electric motor 33 is mounted on the back of the motor base 2. A centrifugal fan 34 is mounted on an output shaft 33a of the electric motor 33 which penetrates through the motor base 32. The centrifugal fan 34 is located in the drum filter chamber 4 formed at the rear of the main filter chamber 3. A partition wall 35 partitions the main filter chamber 3 and drum filter chamber 4. The drum fan 34 is enclosed by an annular drum member 36, and the drum member 36 is mounted on and secured to the backside of the partition wall 35. The drum member 36 is wrapped up with a drum filter 38 on the outer circumferential plane 36a.

As shown in FIG. 2, the drum filter 38 is comprised of a sponge-like filter 40 formed, by way of example, of polyurethane foam, and a fibrous filter 39 formed, by way of example, of polyester nonwoven fabric. More specifically, the drum filter 38 is a unit of the sponge-like filter 40 formed into a band with a generally same width as that of the drum member 36 and the fibrous filter 39 formed into the same band shape, which are seamed together at the peripheral edges.

The drum filter 38 is provided at opposite end regions 38a and 38b in a length direction with two holes 41, respectively. In order to fix the drum filter 38 to the drum member 36, the drum filter 38 is firstly wrapped around the drum filter 36 such that the opposite end regions 38a and 38b overlap with each other and the holes 41 are mated. Then butterfly bolts 43 are inserted through the holes 41, via a filter holding member 42, and fastened into female screw sections 37a formed on the drum member 36.

Two sets of the female screw sections 37 are provided on left and right sides of the drum member 36, respectively. As described later, when a drum filter 38 is replaced from the left side 2b, the female screw sections 37b on the opposite side are used (see FIG. 2). The drum filter 38 is to sorb oil mist contained in the sucked-in gas which has passed through the main filter 10 and been centrifuged by the centrifugal fan 34.

As shown in FIG. 2, the housing 2 includes, respectively on the right side 2a and left side 2b, a drum filter ejection opening 46, via which the drum filter 38 constructed as described above is taken out of the housing 2 (drum filter chamber 4).

To paraphrase, a right drum filter ejection opening (or a first drum filter ejection opening) 46a and a left drum filter ejection opening (or a second drum filter ejection opening) 46b are formed on opposite sides of the drum filter chamber 4 so as to confront each other. Thus the drum filter 38 can be mounted or dismounted either via the right side 2a or via the left side 2a.

Each one side cover 48 is attached respectively on the right side 2a and on the left side 2b of the housing 2. Each of the side covers 48 is screwed with lock knobs (or bolts) formed at four corners of the side cover, and is secured to laterals of the housing 2. A right side cover (or a first cover member) 48a lids both the right main filter ejection opening 26a and right drum filter ejection opening 46a disposed side by side on the right side 2a of the housing 2.

A left side cover (or a second cover member) 48b lids both the left main filter ejection opening 26b and left drum filter ejection opening 46b disposed side by side on the left side 2b of the housing 2. The left side cover 48b is provided on its inner surface 48ba with a guide plate (or a first guide element) 50a for guiding a drum filter 38, which has been inserted from the right drum filter ejection opening 46a, to go around the drum member 36.

The right side cover 48a is also provided on its inner surface 48aa with a guide plate (or a second guide element) 50b for guiding a drum filter 38, which has been inserted from the left drum filter ejection opening 46b, to go around the drum member 36. Each of the guide plates 50a and 50b is so inclined as to be parallel to the outer circumference of the lower region of the drum member 36. When the side cover 48a/48b is mounted on the housing 2, the guide plate 50a/50b protrudes toward the drum filter chamber 4 from the drum filter ejection opening 46a/46b.

The after filter chamber 5 is located in an upper region of the housing 2. The after filter chamber 5 communicates with the drum filter chamber 4. A receptacle (or a after filter case) 56 and an after filter 52 set on the receptacle 56 are located in the after filter chamber 5. The after filter chamber 5 also includes on the back side with an opening (or an after filter ejection opening) 57 through which the receptacle 56 and after filter 52 are set in the after filter chamber 5. The after filter ejection opening 57 is covered by a rear side cover 58, which is mounted on the housing 2 from the back side. As the side covers 48a and 48b, the rear side cover 58 is secured to the housing 2 with lock knobs (bolts) 59. If the lock knobs 59 are undone and the rear side cover 58 is removed, the after filter 52 and the receptacle 56 can be drawn out rearward in a horizontal direction, via the after filter ejection opening 57. The location of the receptacle 56 where the after filter 52 is placed is formed into a grille such that the sucked-in gas can pass there through upward, in an up and down direction.

As shown in FIG. 2, the after filter 52 is comprised of a wooden frame 53 that encircles four sides and a fibrous filter 54 made of nonwoven fabric and attached inside the frame 53. The after filter 52 is to capture fine particles of 0.3 to 2 μm contained in the sucked-in gas which has passed through the drum filter 38.

An upper cover 60 is attached to the top of the housing 2. The upper cover 60 is provided with a discharge port 61. The discharge port 61 serves to exhaust clean air, i.e., the air which has been sucked into the dust collector 1 and has passed through the filters; the main filter 10, the drum filter 38, and the after filter 52, and has therefore been cleaned.

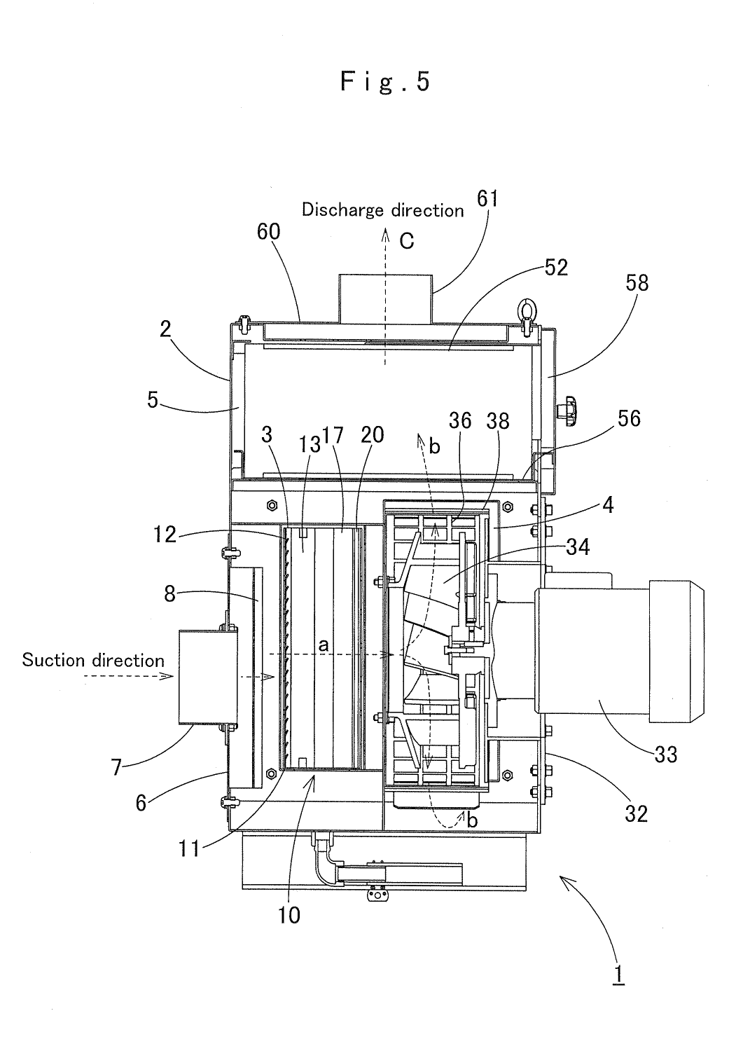

The operation of the dust collector 1 constructed as described above is now described referring to FIG. 5. When the electric motor 33 is actuated, the centrifugal fan 34 runs, and this causes pressure reduction in the dust collector 1, such that an oil mist laden gas is sucked into the dust collector 1 via an unillustrated duct connected to the suction port 7. The oil mist laden gas is then diffused by the first louver 8 and filtrated by the main filter 10 (see an arrow a in FIG. 5). Subsequently the gas is filtrated by the drum filter 38 (see an arrow b in FIG. 5) and further filtrated by the after filter 52, and then discharged from the discharge port 61 (see an arrow c in FIG. 5).

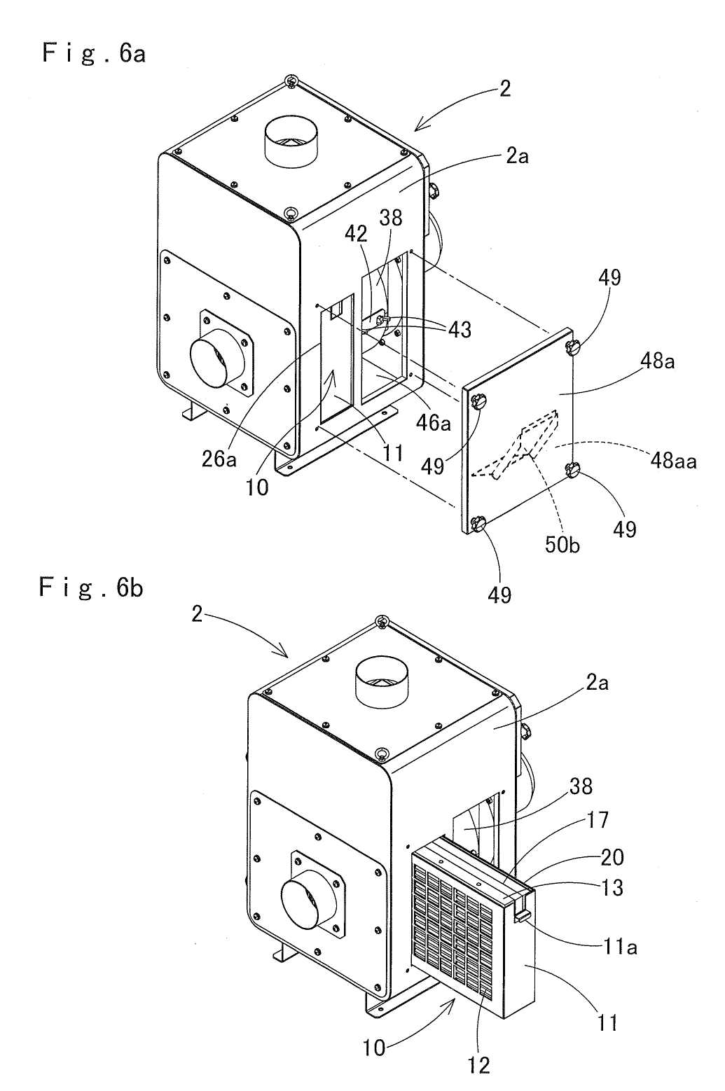

Maintenance of the dust collector 1 is now described referring to FIGS. 6 to 10. To do maintenance on the main filter 10 and drum filter 38, the right side cover 48a is firstly removed by undoing the lock knobs 49, as shown in FIG. 6a. In this embodiment, the right side main filter ejection opening 26a and the right side drum filter ejection opening 46a can be both exposed by removing the right side cover 48a.

Thus a maintenance worker can check how dirty the drum filter 38 is, as shown in FIG. 6a, as well as how dirty the demister 13, air filter 17 and oil blotter 20, which constitute the main filter 10, are, when drawing the cartridge box 11 out as shown in FIG. 6b.

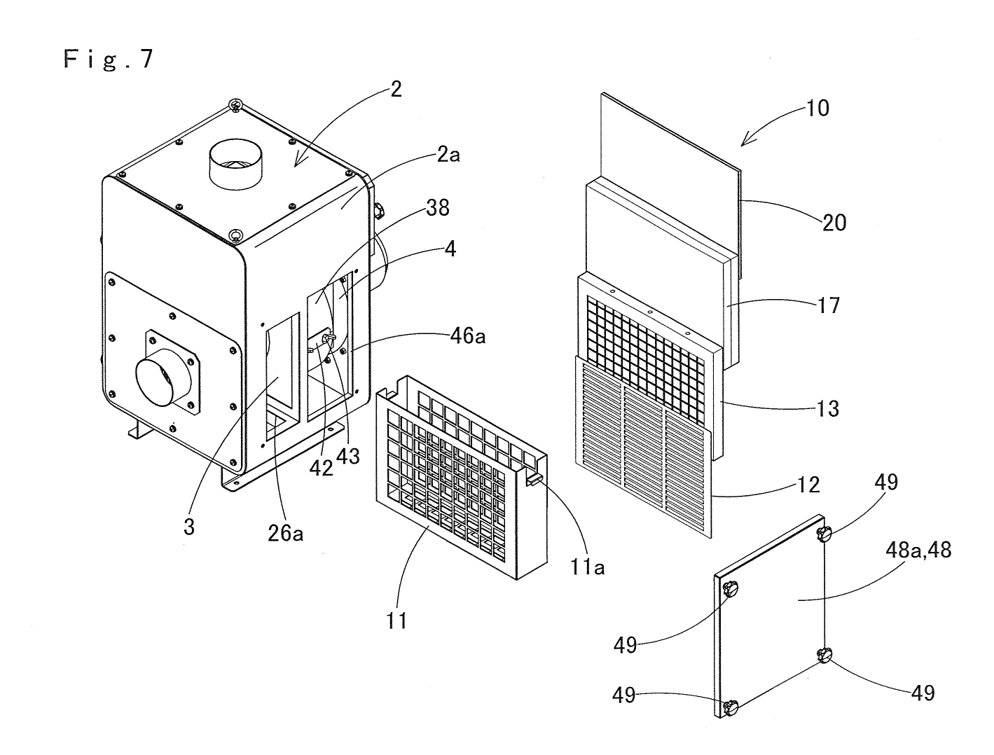

If the demister 13 and/or the air filter 17 are/is very dirty and require(s) cleaning, they are taken out of the cartridge box 11, as shown in FIG. 7, and cleaned. If the oil blotter 20 is very dirty due to sorbed oil mist, it can also be taken out of the cartridge box 11 and replaced with a new one.

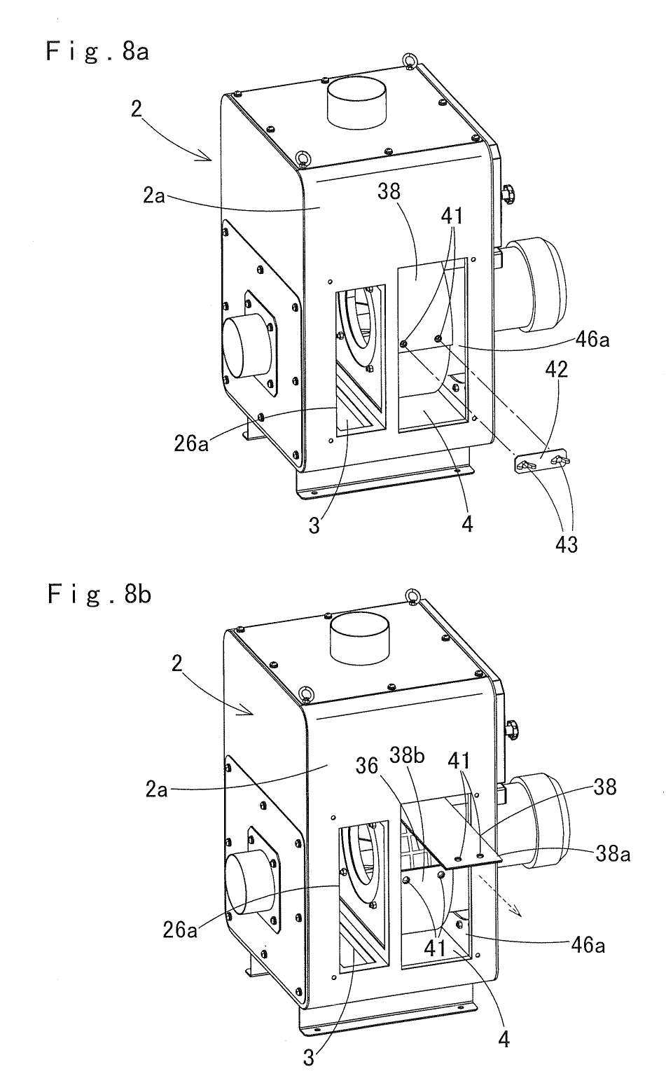

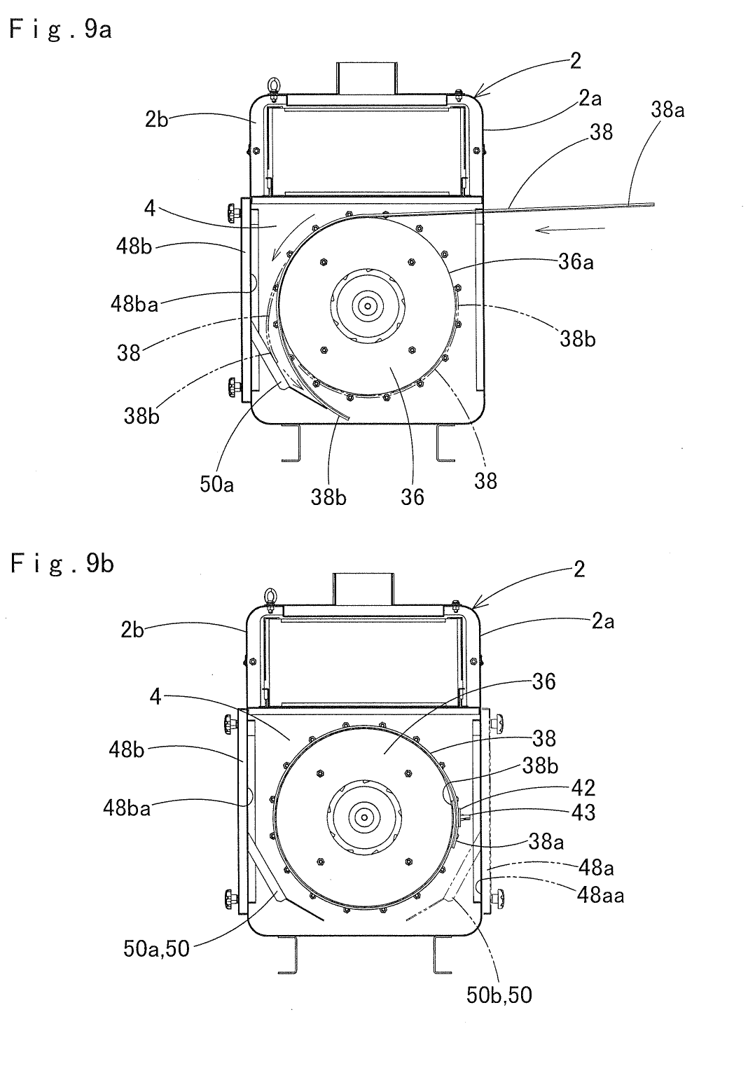

If the drum filter 38 is so dirty as to require replacement, it is dismounted from the drum member 36 by undoing the butterfly bolts 43 and removing the filter holding member 42 as shown in FIG. 8a. Then the drum filter 38 is drawn out of the drum filter chamber 4. Subsequently, a new drum filter 38 is inserted into a space above the drum filter 36 as shown in FIG. 9a. Then the guide plate 50a guides the end region 38b of the drum filter 38 such that the end region 38b moves along the outer circumference 36a of the drum member 36 and moves the right drum filter ejection opening 46a. The opposite end regions 38a and 38b of the drum filter 38 are then laid one over the other and fastened with the butterfly bolts 43, with the filter holding member 42 interposed between the drum filter 38 and bolts 43, as shown in FIG. 9b.

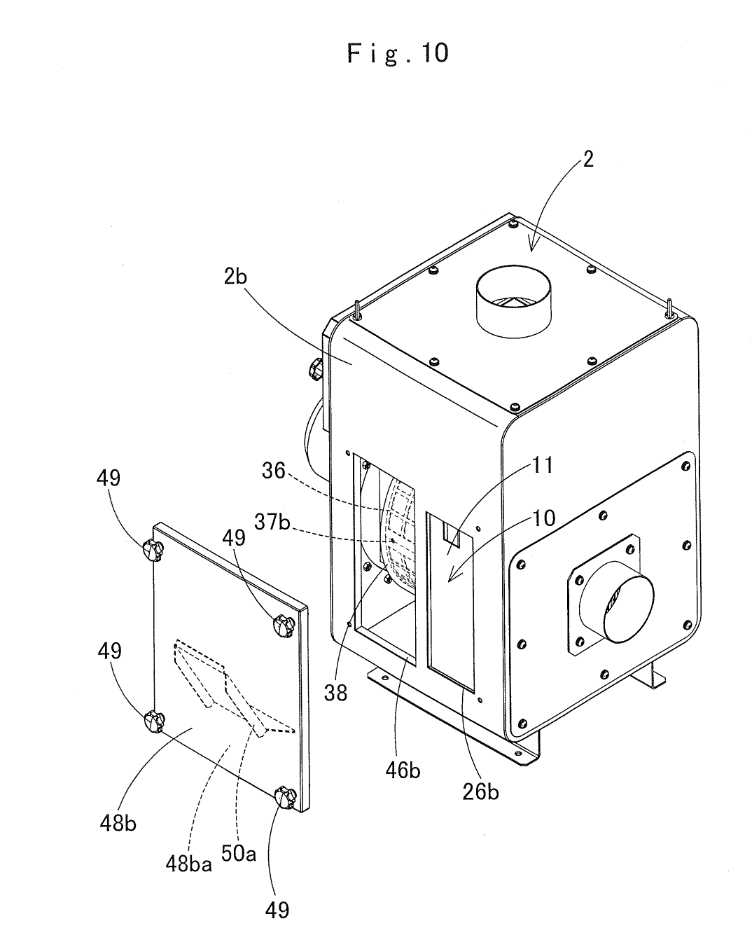

As shown in FIG. 10, maintenance on the main filter 10 and drum filter 38 can also be done from the opposite side of the housing 2, i.e., from the left side 2b. Specifically, the dust collector 1 is provided with the left side cover 48b that will expose, when removed, the left main filter ejection opening 26b and left drum filter ejection opening 46b. That is, the main filter 10 or the cartridge box 11 can be pulled out of the left main filter ejection opening 26b for inspection and replacement as well as the drum filter 38 can be drawn out of the left drum filter ejection opening 46b for removal and replacement.

If mounting and dismounting of the drum filter 38 are conducted from the left side drum filter ejection opening 46b, the female screw sections 37b formed on the left side of the drum member 36 can be used. In this instance, when the drum filter 38 is mounted, the guide plate 50b formed on the inner surface 48aa (FIG. 9b) of the right side cover 48a will guide the drum filter 38 to move along the outer circumference 36a of the drum member 36.

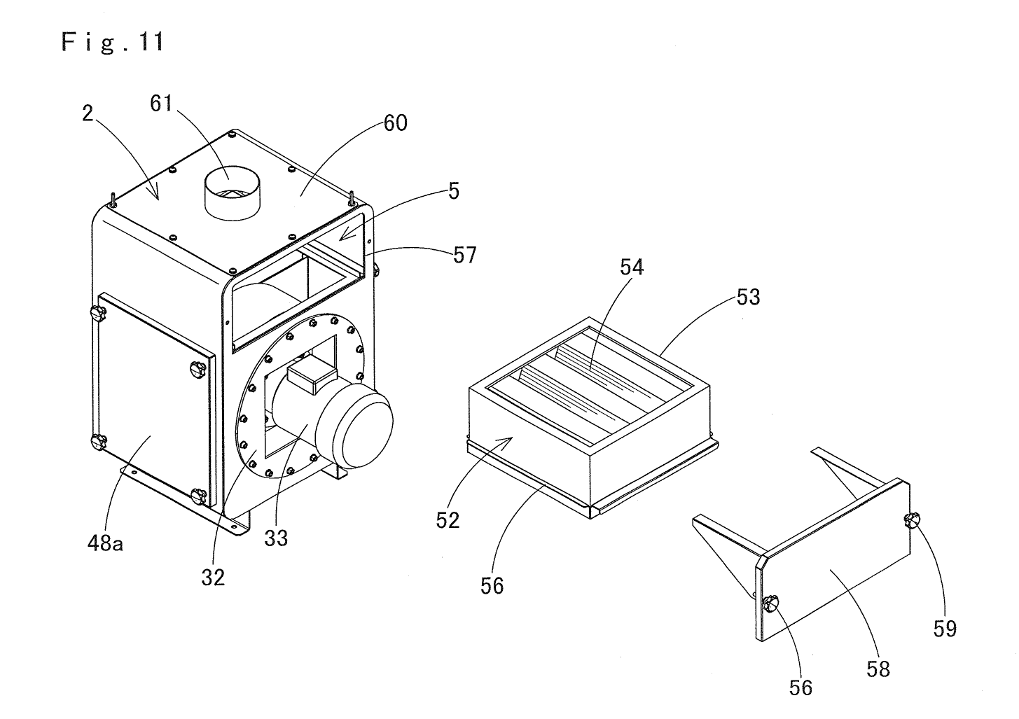

To do maintenance on the after filter 52, the rear side cover 58 is removed by undoing the lock knobs 59 as shown in FIG. 11, such that the after filter 52 is drawn out rearward together with the receptacle 56 for inspection. If the after filter 52 is so dirty as to require replacement, the after filter 52, which is dirty due to collected oil mist, is removed and replaced with a new filter, which is placed on the receptacle 56, and the receptacle 56 is stored again in the after filter chamber 5.

In the dust collector 1 constructed as described above, the main filter 10 is comprised of two or more filter elements selected from a plurality of filters which have the same or different oil mist collection efficiencies. Other than the three filter elements adopted in the illustrated embodiment, i.e., other than the demister 13, the air filter 17 and the oil blotter 20, a metal fiber demister 63 shown in FIG. 3b, a wire mesh demister 64 shown in FIG. 3c and so on, by way of example, can be selected to constitute the main filter 10.

The metal fiber demister 63 has such a structure that a plurality of layers of metal fiber filters 65 are sandwiched by wire meshes 66 at the front and rear, and further clamped by a front frame 67 and a rear frame (unillustrated). The metal fiber demister 63 is finer in mesh size than the demister 13 shown in FIG. 3a (hereinafter referred to as the “standard demister” 13), and therefore is capable of collecting very fine particles. The wire mesh demister 64 is formed by laying a plurality of wire mesh filters 68 one on top of another and clamping them with a front frame 69 and a rear frame (unillustrated). The demister 64 is coarser in mesh size compared to the standard demister 13, and therefore is not capable of trapping very fine particles.

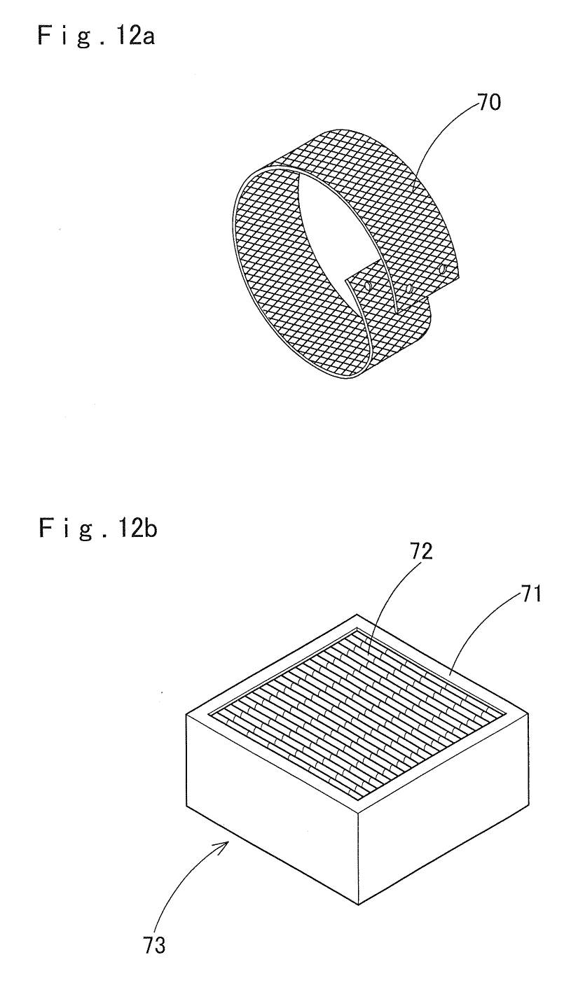

The drum filter 38 is also comprised of a filter element selected from a plurality of filters with different oil mist collection efficiencies. Other than the drum filter of synthetic resin (hereinafter referred to as the “synthetic resin drum filter” 38) adopted in the foregoing embodiment, a metal drum filter 70 shown in FIG. 12a, for example, can be used to constitute the drum filter. The metal drum filter 70 consists of a metallic madreporic body which has 30 to 150 pores per square inch. Although the metal drum filter 70 is inferior in collection efficiency to the synthetic resin drum filter 38, it does not need replacement and therefore requires less maintenance, because it is made of metal and is thus washable.

Further, the after filter 52 is also comprised of a filter element selected from a plurality of filters with different oil mist collection efficiencies. Other than the filter element adopted in the foregoing embodiment for the after filter 52, a high performance after filter 73 shown in FIG. 12b, for example, can be used to constitute the after filter. The high performance after filter 73 is comprised of a wooden frame 71 that encircles four sides and a numerous so-called HEPA filters 72 arranged, inside the frame 71, along the flow direction of the sucked-in gas. The high performance after filter 73 has higher collection efficiency than the after filter 52 shown in FIG. 2 though it requires more frequent maintenance (i.e., replacement). The HEPA filter 72 is a cloth like filter made of very fine fibers with about 1 μm diameter.

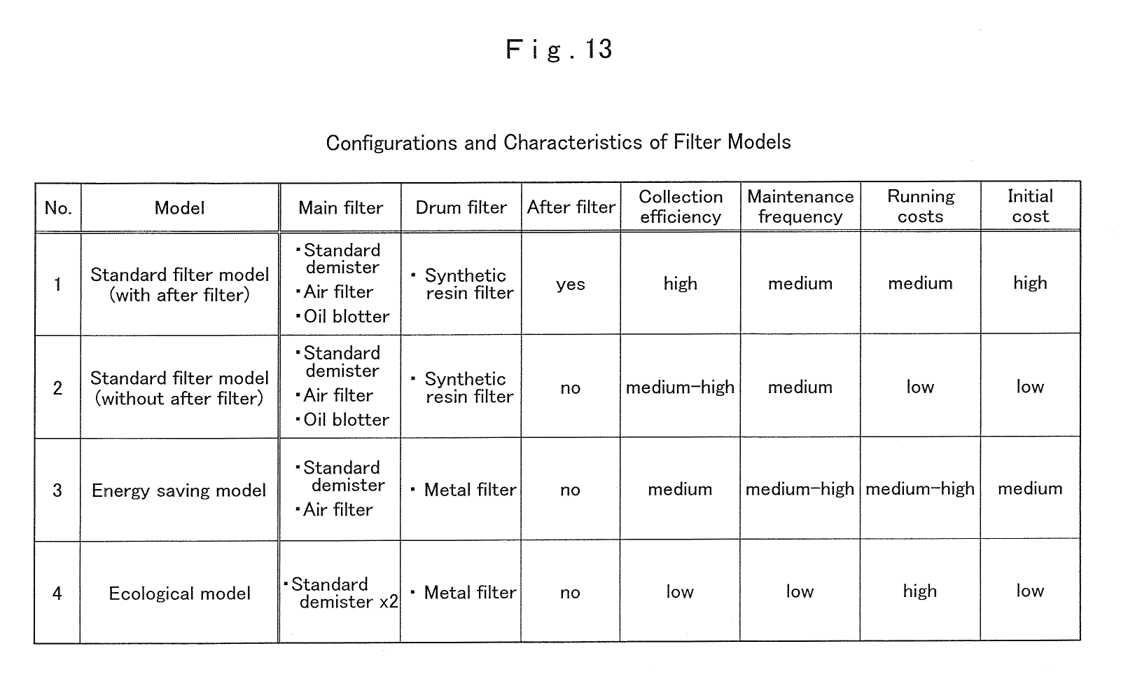

A table in FIG. 13 shows several exemplar models of the dust collector embodying the invention and characteristics thereof. Each of the models includes different filters. Four models are here shown as examples with varied filters; a “standard filter (with an after filter) model”, a “standard filter (without an after filter) model”, an “energy saving model” and an “ecological model”.

The standard filter (with an after filter) model is the dust collector 1 illustrated in the foregoing embodiment, that is, as shown in FIG. 13, it uses a standard demister 13, an air filter 17 and an oil blotter 20 together as constituents of the main filter 10, uses a synthetic resin drum filter 38 as the drum filter 38, and is usually equipped by an after filter 52, which may optionally be replaced with a high performance after filter 73 shown in FIG. 12b, for collection of even finer particles.

In contrast, the standard filter (without an after filter) model is the same as the standard filter (with an after filter) model in configuration of the main filter and the drum filter, but does not include an after filter 52, as shown in FIG. 13. That is, it uses a standard demister 13, an air filter 17 and an oil blotter 20 together as the main filter 10, and uses a synthetic resin drum filter 38 as the drum filter 38.

The standard filter (without an after filter) model may be optionally provided with a discharge filter (not shown) on the receptacle 56, instead of using no after filter 52. The discharge filter is an auxiliary filter for preventing dust from entering into the dust collector 1 via the discharge port 61 and for trapping dust contained in the sucked-in gas which has passed through the drum filter 38.

The energy saving model uses a standard demister 13, an air filter 17 and no oil blotter 20 as the main filter 10, uses a metal drum filter 70 as the drum filter, instead of a synthetic resin drum filter 38, and does not include an after filter 52. That is, the energy saving model uses cleanable filters, i.e., the demister 13, the air filter 17 and the metal drum filter 70, instead of uncleanable oil blotter 20, synthetic resin drum filter 38 and after filter 52. Accordingly, this model will reduce filter change-out frequency and save on running costs in comparison with the standard filter models.

The ecological model uses two standard demisters 13 as the main filter 10, without an oil blotter 20 and an air filter 17, uses a metal drum filter 70 as the drum filter, and includes no after filter 52. That is, the ecological model is such a model that is capable of running for a long time only with inspection and cleaning of filters, by not using such filters that would require replacement and disposal, i.e., an air filter 17, an oil blotter 20, a synthetic resin drum filter 38 and an after filter 52.

The ecological model will be suitable especially for use in a machine shop with a aluminum die-casting machine. Mist generated in such a machine shop is a mixture of mold release agent and water vapor and contains large-diameter particles. If finer filters adopted in other models are used to collect such mist, the filters will be soon clogged, thereby requiring frequent maintenances and increasing running costs. Therefore the ecological model comprised of the demister 13 and metal drum filter 70 will be recommended.

In the ecological model, a metal fiber demister 63 (FIG. 3b), which is capable of collecting finer particles, may be alternatively located at the rear of the standard demister 13, instead of using double standard demisters 13. Further alternatively, a wire mesh demister 64 (FIG. 3c), which is coarse, may be located in front of a standard demister 13.

With the combination of the standard demister 13 and metal fiber demister 63, however, maintenance will be more frequently required than the instance of double standard demisters 13 in contradiction to improvement in collection efficiency, since the metal fiber demister 63 requires frequent maintenances. In this instance, selection of demisters should be determined depending on characters of mist and dust to be collected by the dust collector 1.

The table in FIG. 13 shows comparisons of performances of the four models, i.e., the collection efficiencies, maintenance frequencies, running costs and an initial cost. The standard filter (with an after filter) model is highest in collection efficiency, and the standard filter (without an after filter) model, the energy saving model and the ecological model follow in that order. To the contrary, the ecological model is the best (i.e., lowest) in maintenance frequency, then the energy saving model, the standard filter (without an after filter) model, and the standard filter (with an after filter) model follow in that order.

As described above, the dust collector 1 includes the housing 2 provided with the suction port 7 and the discharge port 61, the motor-driven centrifugal fan 34 located in the drum filter chamber (or fan chamber) 4 in the housing 2, the main filter chamber (or air suction chamber 3) located between the suction port 7 and the drum filter chamber (or fan chamber) 4, the main filter 10 located in the main filter chamber 3, the drum member 36 that is so located in the drum filter chamber 4 as to enclose the centrifugal fan 34, and the drum filter 38 mounted around the outer circumferential plane 36a of the drum member 36. When an oil mist laden gas is sucked into the housing 2 via the suction port 7 due to running of the centrifugal fan 34, the dust collector 1 filtrates the gas with the main filter 10, and then with the drum filter 38, and exhausts the filtrated gas from the discharge port 61.

The main filter 10 is comprised of the box-shaped cartridge box (or filter case) 11 that is ejectable from the main filter chamber 3 and two or more filter elements (the standard demister 13, the air filter 17 and the oil blotter 20, in this specific embodiment) that are set in the cartridge box 11 in layers, and the filter elements are selected from a plurality of filters which have the same or different performances, such as the standard demister 13, air filter 17, oil blotter 20, metal fiber demister 63 and wire mesh demister 64.

With the dust collector 1, collection efficiency and maintenance frequency (see FIG. 13) of the dust collector will be easily changed by taking the cartridge box (or filter case) 11 out of the main filter chamber (air suction chamber) 3 and replacing the filter elements in the main filter 10 selectively with other filter elements, i.e., by changing the selection of the standard demister 13, air filter 17, oil blotter 20, metal fiber demister 63 or wire mesh demister 64.

Accordingly, the dust collector 1 is capable of responding to such instances where, after being introduced in a shop, collection efficiency must be changed due to change of a cutting fluid etc. or where the dust collector 1 is re-mounted on other machine tool which demands different collection efficiency, merely by replacing the filters, without having to repurchasing a new dust collector.

Moreover, the drum filter 38 of the dust collector 1 is formed into a generally band shape and is so configured as to be moved along its length direction so as to be taken in and out of the drum filter chamber (or fan chamber) 4 and wrapped around the outer circumferential plane 36a of the drum member 36. Further, the drum filter 38 is comprised of one filter element selected from a plurality of filters with different performances, i.e., selected from the synthetic resin drum filter 38 and metal drum filter 70.

With this configuration, therefore, performance of the dust collector 1 can be easily changed by taking the drum filter 38 out of the drum filter chamber (fan chamber) 4 along its length direction and wrapping a metal drum filter 70 with different performance around the drum member 36. Since not only the selection of the filter elements for the main filter 10 but also the selection of the filter element for the drum filter (i.e., a synthetic resin drum filter 38 or a metal drum filter 70) can be changed, various combinations of filter elements will enable diverse performance possibilities of the dust collector 1.

The dust collector 1 further includes the after filter chamber (or air exhaust chamber) 5 located between the drum filter chamber (fan chamber) 4 and the discharge port 61, the receptacle (or after filter case) 56 removably located in the after filter chamber 5 and the after filter 52 that is set in the receptacle 56 and filtrates a gas having passed through the drum filter 38. The after filter 52 is comprised of one filter element selected from a plurality of filters with different performances, i.e., from the after filter 52 and high performance after filter 73.

With this configuration, performance of the dust collector 1 can be easily changed by taking the receptacle (after filter case) 56 out of the after filter chamber (air exhaust chamber) 5 and replacing the after filter 52 with another filter element of different performance, i.e., with a high performance after filter 73. Since the selection of the filter element is also possible with the after filter (i.e., an after filter 52 or a high performance after filter 73) in addition to the main filter 10 and the drum filter 38, there will be further diverse performance possibilities of the dust collector 1 depending on various combinations of filter elements.

In the dust collector 1, moreover, at least one of the filter elements constituting the main filter 10, i.e., the air filter 17 and oil blotter 20 in the illustrated embodiment, are comprised of two or more filters out of sponge-like synthetic resin filters and/or fibrous filters, laid one above the other and spot heat sealed.

With this configuration, the filters can be unitized without impairing filter performance. If the two filters are unitized by sewing, the sewn regions will be clamped against each other, which will reduce a filterable area and is not desirable.

In the dust collector 1, the main filter 10 is comprised of the box-shaped cartridge box (or filter case) 11 that is ejectable from the main filter chamber (or air suction chamber) 3 and the filter elements (the standard demister 13, the air filter 17 and the oil blotter 20, in this specific embodiment) housed therein. The dust collector 1 further includes the right main filter ejection opening (or the first main filter ejection opening) 26a for ejection of the main filter 10 out of the main filter chamber 3 and the right drum filter ejection opening (or the first drum filter ejection opening) 46a for ejection of the drum filter 38 out of the drum filter chamber (or the fan chamber) 4. The right main filter ejection opening 26a and the right drum filter ejection opening 46a are disposed side by side on the right side (i.e., on a lateral side) 2a of the housing. The dust collector 1 further includes the right side cover (or first cover member) 48a that covers both the right main filter ejection opening 26a and the right drum filter ejection opening 46a.

With this configuration, the main filter chamber (air suction chamber) 3 housing the main filter 10 and the drum filter chamber (fan chamber) 4 housing the drum filter 38 can be both checked from the right side (the lateral side) 2a of the housing 2 merely by removing the right side cover (first cover member) 48a. If the cartridge box (filter case) 11 is further taken out of the main filter chamber 3, the filter elements (standard demister 13, air filter 17 and oil blotter 20) of the main filter 10 can be checked, thus facilitating maintenance work on the filters, such as inspection and replacement.

In the dust collector 1, the drum filter 38 is formed into a generally band shape and is so configured as to be moved along its length direction so as to be taken in and out of the right drum filter ejection opening 46a and wrapped around the outer circumferential plane 36a of the drum member 36. The dust collector 1 includes the guide plate (or first guide element) 50a that guides the leading end region 38b of the drum filter 38 inserted from the right drum filter ejection opening 46a to move along a circumferential direction of the drum member 36 and toward the right drum filter ejection opening 46a (FIG. 9a).

With this configuration, when the drum filter 38 is mounted on the drum member 36, the guide plate (or first guide element) 50a guides the leading end region 38b of the drum filter 38 inserted from the right drum filter ejection opening 46a to move along a circumferential direction of the drum member 36 and toward the right drum filter ejection opening 46a, merely by inserting the drum filter 38 via the right drum filter ejection opening 46a and moving it along its length direction. Then if the leading end region 38a having gone round the drum member 36 and returned to the right drum filter ejection opening 46a and the opposite end region 38b are laid one over the other and fastened together, the drum filter 38 is easily mounted around the drum member 36 (FIG. 9b). This mounting fashion will allow the drum filter ejection opening 46 to be compact and simplify the structure of the housing 2 in comparison with an instance where a drum filter 38 would be provided in an annular shape and taken in and out along an axial direction of the drum member 36.

The dust collector 1 is also provided with the left main filter ejection opening (second main filter ejection opening) 26b which is identical to the right main filter ejection opening 26a and the left drum filter ejection opening (second drum filter ejection opening) 46b which is identical to the right drum filter ejection opening 46a, on the left side (i.e., on the opposite side) 2b of the housing 2, side by side. The dust collector 1 further includes the left side cover (second cover member) 48b that covers both the second main filter ejection opening 26b and the second drum filter ejection opening 46b. Thus the main filter 10 may be taken in and out of the main filter chamber (air suction chamber) 3 either via the right main filter ejection opening 26a or via the left main filter ejection opening 26b whereas the drum filter 38 may be taken in and out of the drum filter chamber (fan chamber) 4 either via the right drum filter ejection opening 46a or via the left drum filter ejection opening 46b.

With this configuration, if the dust collector 1 is in such an installation environment that would not allow removal of the right side cover (first cover member) 48a, such maintenance as inspection and replacement of the filter can be easily done by removing the left side cover (second cover member) 48b. The installation environment that would not allow removal of the right side cover (first cover member) 48a would be exemplified by such an instance where the right side cover 48a is very close to a wall or an equipment of a shop.

As shown in FIGS. 9a and 9b, moreover, the dust collector 1 includes the guide plate (second guide element) 50b that, when the drum filter 38 is inserted from the left or second drum filter ejection opening 46b and moved along its length direction to be mounted around the drum member 36, guides the leading end region 38a of the drum filter 38 to move along a circumferential direction of the drum member 36 and toward the left drum filter ejection opening 46b. The guide plate 50b is located on the inner surface 48aa of the right side cover or first cover member 48a. On the other hand, the guide plate or first guide element 50a is located on the inner surface 48ba of the left side cover or second cover member 48b so as to guide the leading end region 38b of the drum filter 38, which has been inserted via the right or first drum filter ejection opening 46a to be mounted around the drum member 36, to move along a circumferential direction of the drum member 36 and toward the right drum filter ejection opening 46a.

With this configuration, when a drum filter 38 is replaced by removing the left side cover (second cover member) 48b, if a new drum filter 38 is inserted as shown in FIGS. 9a and 9b after removing the drum filter 38 as shown in FIGS. 8a and 8b, the guide plate or second guide element 50b will help wind the drum filter 38 around the drum member 36, thus facilitating the mounting of the drum filter 38 via the left drum filter ejection opening 46b.

Although the dust collector 1 in the foregoing embodiment is provided on both the right side 2a and left side 2b with the main filter ejection openings 26, the drum filter ejection openings 46 and side covers 48 to cover them, the main filter ejection opening 26 and drum filter ejection opening 46 may be formed only on either one lateral side of the housing 2. In this instance, the guide plate (FIG. 9b) 50 is to be formed on an inner side of the other lateral side where no ejection openings 26 and 46 are formed.

Although the standard demister 13 in the foregoing embodiment is comprised of metal filters 14 each of which is formed by weaving or netting numerous aluminum wires extending in an up and down direction and in a left and right direction, the aluminum wires may be replaced with stainless steel wires. In this instance, oil droplets trapped by the demister run down the stainless steel wires.

In the foregoing embodiment, the air filter (primary synthetic resin filter) 17 is comprised of double sponge-like filter elements 18 which are heat sealed together. However, three or more filter elements may be heat sealed together to form the air filter 17.

Although the after filter 52 in the foregoing embodiment is formed by mounting the fibrous filter 54 inside the wooden frame 53, a metal frame, such as aluminum, or a paper frame may be used instead of the wooden frame.

What is claimed is:

1. A dust collector comprising:
a housing provided with a suction port and a discharge port;
a motor-driven fan located in a fan chamber in the housing;
an air suction chamber located between the suction port and the fan chamber;
a main filter located in the air suction chamber, the main filter being comprised of a box-shaped filter case that is ejectable from the air suction chamber and two or more filters that are set in the filter case in layers, the filters being selected from a plurality of filters which have the same or different performances;
a drum member that is so located in the fan chamber as to enclose the fan; and
a drum filter mounted around an outer circumferential plane of the drum member.

2. The dust collector as in claim 1, wherein the drum filter is formed into a generally band shape and is so configured as to be moved along a length direction of the drum filter so as to be taken in and out of the fan chamber and wrapped around the outer circumferential plane of the drum member.

3. The dust collector as in claim 1 wherein the drum filter is comprised of one filter selected from a plurality of filters which have different performances.

4. The dust collector as in claim 1, further comprising:
an air exhaust chamber located between the fan chamber and the discharge port;
an after filter case removably located in the air exhaust chamber; and
an after filter that is set in the after filter case and filtrates a gas having passed through the drum filter, the after filter being comprised of one filter selected from a plurality of filters with different performances.

5. A dust collector comprising:
a housing provided with a suction port and a discharge port;
a motor-driven fan located in a fan chamber in the housing;
an air suction chamber located between the suction port and the fan chamber;
a main filter located in the air suction chamber, the main filter being comprised of a box-shaped filter case that is ejectable from the air suction chamber and a filter element set in the filter case;
a drum member that is so located in the fan chamber as to encompass the fan;
a drum filter mounted around an outer circumferential plane of the drum member;
a first main filter ejection opening for ejection of the main filter out of the air suction chamber and a first drum filter ejection opening for ejection of the drum filter out of the fan chamber, the first main filter ejection opening and the first drum filter ejection opening being disposed side by side on a lateral side of the housing; and
a first cover member that covers both the first main filter ejection opening and the first drum filter ejection opening.

6. The dust collector as in claim 5, wherein:
the drum filter is formed into a generally band shape and is so configured as to be moved along a length direction of the drum filter so as to be taken in and out of the first drum filter ejection opening and wrapped around the outer circumferential plane of the drum member; and
the dust collector includes a first guide element that guides a leading end region of the drum filter inserted from the first drum filter ejection opening to move along a circumferential direction of the drum member and toward the first drum filter ejection opening.

7. The dust collector as in claim 6 further comprising:
a second main filter ejection opening for ejection of the main filter out of the air suction chamber and a second drum filter ejection opening for ejection of the drum filter out of the fan chamber, the second main filter ejection opening and the second drum filter ejection opening being disposed side by side on a lateral side of the housing opposite from the first main filter ejection opening and the first drum filter ejection opening, such that the main filter may be taken in and out of the air suction chamber either via the first main filter ejection opening or via the second main filter ejection opening whereas the drum filter may be taken in and out of the fan chamber either via the first drum filter ejection opening or via the second drum filter ejection opening; and
a second cover member that covers both the second main filter ejection opening and the second drum filter ejection opening, wherein the first guide element is located on an inner surface of the second cover member.

8. The dust collector as in claim 7 further comprising:
a second guide element that is located on an inner surface of the first cover member and guides a leading end region of the drum filter to move along a circumferential direction of the drum member and toward the second drum filter ejection opening when the drum filter is inserted from the second drum filter ejection opening and moved along a length direction thereof to be mounted around the drum member.
